(19) United States
(12) Patent Application Publication
(10) Pub. No.: US 2026/0027794 A1
(43) Pub. Date: Jan. 29, 2026

(54) PROCESS AND APPARATUS FOR BUILDING TYRES FOR WHEELS OF VEHICLES

(71) Applicant: PIRELLI TYRE S.P.A., Milano (IT)

(72) Inventors: Fabio REGOLI, Milano (IT); Daniele PECORARO, Milano (IT); Stefano MARTINA, Milano (IT); Stefano MONTI, Milano (IT)

(21) Appl. No.: 19/132,432

(22) PCT Filed: Dec. 5, 2023
(86) PCT No.: PCT/IB2023/062224

§ 371 Date: May 23, 2025

(30) Foreign Application Priority Data
Dec. 19, 2022 (IT) 102022000025947

(51) Int. Cl. B29D 30/30; B29D 30/00

(52) U.S. Cl. CPC B29D 30/3042; B29D 30/0061; B29D 2030/0066; B29D 2030/3064

(57) ABSTRACT

A process for building tyres for wheels of vehicles, with the following building operations: winding a cut-to-size semifinished element around a forming drum, thereby forming a corresponding component of a tyre, wherein the semi-finished element has opposite ends juxtaposed with each other to form a junction zone; repeating the winding operation until completion of the building operations on the forming drum. During the building operations, a checking operation is performed on the tyre, including: acquiring a two-dimensional image of the tyre; identifying, in the image, at least one junction zone in a radially external position of the tyre; providing reference images, each representing a junction zone type; comparing the at least one identified junction zone with each reference image; selecting a junction zone type; classifying the at least one identified junction zone on the basis of the junction zone type; and generating a stop or a consent signal.

The present invention relates to a process for building tyres for wheels of vehicles.

The present invention further relates to an apparatus for building tyres for wheels of vehicles.

A tyre for vehicle wheels generally comprises a carcass structure including at least one carcass ply having respectively opposite end flaps in engagement with respective annular anchoring structures, generally referred to as “bead cores”, integrated into the regions usually identified as “beads”, the inside diameter of which substantially matches a so-called “fitting diameter” of the tyre for fitting it onto a respective rim. The tyre also comprises a crown structure including at least one belt strip located in a radially external position relative to the carcass ply, and a tread band which is radially external to the belt strip. Between the tread band and the belt strip(s) a so-called “underlayer” of elastomeric material may be interposed, the properties of which are suitable for providing a stable union between the belt strip(s) and the tread band. In addition, respective sidewalls of elastomeric material are applied to the side surfaces of the carcass structure, each extending from one of the side edges of the tread band to the respective annular bead anchoring structure. In tyres of the “tubeless” type, the carcass ply is internally coated with a layer of elastomeric material, preferably a butyl-based one, commonly referred to as “liner”, which has optimal air tightness properties and extends from one bead to the other.

The term “elastomeric material” refers to a compound comprising at least one elastomeric polymer and at least one reinforcing filler. Preferably, said compound also comprises additives such as, for example, a cross-linking agent and/or a plasticizer. Thanks to the presence of the cross-linking agent, said material can be cross-linked by heating to form the final product.

The term “semifinished element” refers to a continuous elongated element having a flattened cross-section, which is made of elastomeric material.

Preferably, the semifinished element incorporates one or more textile or metallic reinforcing cords, disposed parallel to each other in the longitudinal direction of the same elongated element.

A “component” or “structural component” of a tyre is meant to be any portion of the latter which can perform a specific function, or part thereof. Structural tyre components include, for example: liner, underliner, complex, sidewall inserts, bead cores, filler inserts, anti-abrasive layer, sidewalls, carcass ply(ies), belt layer(s), tread band, underbelt inserts, etc., or part thereof.

The expression “tyre being processed” refers to a structure formed of one or more structural components of the tyre.

By “digital image”, or equivalently “image”, it is generally meant a set of data, typically contained in a computer file, in which each tuple of coordinates (typically each pair of coordinates) of a finite set (typically two-dimensional and matrixial, i.e. N rows×M columns) of tuples of spatial coordinates (each tuple corresponding to one “pixel”) is associated with a corresponding set of numerical values (which may be representative of different magnitudes). For example, in monochrome images (such as those in gray levels, or “grayscale”), such set of values consists of a single value in a finite scale (typically 256 levels or tones), such value being, for example, representative of the luminosity (or intensity) level of the respective tuple of spatial coordinates when displayed. A further example is represented by colour images, in which the set of values represents the luminosity level of a plurality of colours or channels, typically the primary colours (e.g. red, green and blue in RGB coding, or cyan, magenta, yellow and black in CMYK coding). The term “image” does not necessarily imply the actual visualization of the same.

Any reference to a specific “digital image” (e.g. the digital image initially acquired on the tyre) includes, more generally, any digital image obtainable through one or more digital processing operations conducted on said specific digital image (such as, for example, filtering, equalization, smoothing, binarization, thresholding, morphological transformations (“opening”, etc.), derivative or integral calculations, etc.).

The term “two-dimensional image”, or “2D image”, refers to a digital image wherein each pixel is associated with a piece of information representative of the reflectivity/diffusivity and/or colour of the surface, as in images acquired by common digital cameras (e.g. CCD cameras, CMOS cameras, etc.).

The term “resolution” refers to the minimum distance between two distinct points that can be identified within an image. For example, a resolution of 0.3 mm permits identifying two distinct points at a mutual distance greater than or equal to 0.3 mm, while it does not permit identifying two distinct points at a distance of, for example, 0.2 mm.

A “high resolution” is a resolution of less than or equal to 0.3 mm, preferably in the range of approximately 0.01 mm to approximately 0.3 mm, even more preferably in the range of approximately 0.05 mm to approximately 0.3 mm.

A “digital camera”, or simply “camera”, is an optoelectronic device adapted to acquire a two-dimensional digital image and including a digital image sensor (or simply “sensor”), which defines an image plane, and an objective (which for simplicity is assumed to have cylindrical symmetry, although the invention is not limited to such objectives only).

A “sensor” is meant to be a set of photosensitive elements (called “pixels”) capable of transforming incident light into an electric signal, e.g. by CCD or CMOS technology. The term pixel is used herein to denote both the single photosensitive element of the sensor and the single element forming the digital image as defined above, each pixel of the sensor typically corresponding to a pixel of the image.

A “matrix camera” is a camera whose sensor has the pixels arranged according to a rectangular matrix whose two dimensions have comparable lengths (for example, the two dimensions differ by less than one order of magnitude, as in the 4×3 or 3×2 formats). Typically, the diagonal of the sensor matrix is a few tens of millimetres long.

During a tyre building process, some components (e.g. the tread band) are laid circumferentially around a respective drum so that, when the laying is complete, the opposite ends of the components are juxtaposed to form a so-called “junction zone”.

Document DE 10036010 A1 describes a system wherein plies used for building a tyre are positioned under one or more laser sources, each one of which projects a luminous strip onto the plies. A CCD camera is directed towards the luminous strips to determine the height of the material of the plies in the junction zones.

Document DE 102012016587 A1 describes a method wherein the tyre structure material, in the form of a strip, is deposited onto a drum; the structure material is moved under laser sources. Light areas are projected by the laser sources onto the structure material. Cameras are directed towards the light areas to determine a height profile of the surface of the structure material.

Document WO 2015/056192 A1 by the present Applicant describes a method for controlling the laying of tyre components on forming drums. The method comprises: sending a first electromagnetic radiation incident on a first laying structure comprising a forming drum and a first tyre component laid on said forming drum; detecting at least a first corresponding reflected radiation; determining, as a function of said first reflected radiation, a first parameter representative of a first main length of said first component; comparing said first parameter with one or more pre-stored reference values; generating a first correction signal as a function of said comparison; sending said first correction signal to at least one preparation station adapted to prepare said first component to regulate the preparation of further components.

The Applicant has verified that several factors, including material variability, product specifications and machinery conditions, may cause a certain degree of variability during the making of the junction zones.

In this regard, the Applicant observes that it is important that the junction zone is made in a correct and precise manner: the two opposite ends must not be too distant from each other or form a region with excessive overlap, otherwise the quality and performance of the tyre may be jeopardized.

Typically, the junction zone is checked visually by an operator: when the laying of the component is complete, the tyre being processed is moved to an area accessible to the operator, and the latter visually examines the junction zone and decides whether to let the building process continue or to carry out any necessary component repair/replacement operations.

The Applicant noticed that visual checks are reliable and repeatable when carried out by skilled personnel, but may sometimes take time longer than acceptable in an in-line process conceived to operate with substantially no interruptions.

The Applicant also noticed that the systems described in documents DE 10036010 A1, DE 102012016587 A1 and WO 2015/056192 A1, whilst based on more advanced techniques than simple visual checks, require quite complex structures in terms of illumination/detection instrumentation and also in terms of operator protection structures. Such structures are, in fact, necessary to protect the personnel working on the tyres from exposure to laser radiations.

In this context, the Applicant perceived that, by simplifying the optical instrumentation components (mainly the emitter/receiver) and making it less critical in terms of operator interaction, and by using improved software functions, it would be possible to obtain a system that remains precise and reliable without creating any safety risks for the operators involved.

As perceived by the Applicant, the solution should ensure reliable and repeatable control over the quality of the junction zones. The solution should also allow integration into an in-line building process, without introducing any pauses or delays in the production cycle.

The Applicant finally found a solution comprising the acquisition of images in the visible spectrum—or in other wavelength ranges that are not dangerous for operators—and the processing of such images in a succession of identification-classification steps, so as to recognise the presence and the characteristics of the junction zone and permit the detection of any potential criticalities.

In accordance with a first aspect, the invention relates to a process for building tyres for wheels of vehicles.

Preferably, the process comprises building operations.

Preferably, the building operations comprise:
a) providing a first forming drum rotating about its central axis.

Preferably, the building operations comprise:
b) winding around a radially external surface of said first forming drum a cut-to-size semifinished element, thereby forming a corresponding component of a tyre being processed.

Preferably, said semifinished element has, after having been wound around said first forming drum, opposite ends juxtaposed with each other to form a junction zone.

Preferably, the building operations comprise:
c) repeating operation b) until completion of the building operations on said first forming drum.

Preferably, a checking operation is performed on said tyre being processed.

Preferably, said checking operation is performed during said building operations.

Preferably, said checking operation is performed at least at the end of an operation b).

Preferably, said checking operation comprises acquiring at least one two-dimensional image of said tyre being processed.

Preferably, said building operation comprises identifying, in said image, at least one junction zone in a radially external position of said tyre being processed.

Preferably, said building operation comprises providing a plurality of reference images.

Preferably, each reference image represents, whether alone or combined with one or more other reference images, a junction zone type.

Preferably, said checking operation comprises comparing said at least one identified junction zone with each one of the reference images.

Preferably, said checking operation comprises selecting, as a function of said comparison, a junction zone type corresponding to said at least one junction zone identified in said image.

Preferably, said checking operation comprises classifying said at least one identified junction zone on the basis of the selected junction zone type.

Preferably, said checking operation comprises generating, as a function of said classification, either a stop signal or a consent signal.

Preferably, said stop signal causes said building operations to stop.

Preferably, said consent signal activates the execution of subsequent operations on said tyre being processed.

In accordance with a second aspect, the invention relates to an apparatus for building tyres for wheels of vehicles.

Preferably, the apparatus comprises a first forming drum rotating about its central axis.

Preferably, the apparatus comprises a first building device.

Preferably, the first building device is configured for winding around a radially external surface of said first forming drum a cut-to-size semifinished element, thereby forming a corresponding component of a tyre being processed.

Preferably, said semifinished element has, after having been wound around said first forming drum, opposite ends juxtaposed with each other to form a junction zone.

Preferably, the apparatus comprises a control system.

Preferably, the control system comprises a memory, which stores a plurality of reference images.

Preferably, each reference image represents, whether alone or combined with one or more other reference images, a junction zone type.

Preferably, the control system comprises a detection device.

Preferably, the detection device is configured for acquiring at least one two-dimensional image of said tyre being processed.

Preferably, the control system comprises a processing device.

Preferably, the processing device is configured for identifying, in said image, at least one junction zone in a radially external position of said tyre being processed.

Preferably, the processing device is configured for comparing said at least one identified junction zone with each one of the reference images.

Preferably, the processing device is configured for selecting, as a function of said comparison, a junction zone type corresponding to said at least one junction zone identified in said image.

Preferably, the processing device is configured for classifying said at least one identified junction zone on the basis of the selected junction zone type.

Preferably, the processing device is configured for generating, as a function of said classification, either a stop signal or a consent signal.

Preferably, said stop signal causes said building device to stop.

Preferably, said consent signal activates the execution of subsequent operations on said tyre being processed.

The Applicant believes that this solution, based on the use of selected wavelengths for image acquisition and on a particular processing of such images, makes it possible to detect, in a safe, reliable and repeatable manner, any potential criticalities that may be present in the junction zones while building a tyre, which detection occurs immediately after each junction is made, thus avoiding a delayed rejection of the tyre at subsequent stages of the building process, which would result in much higher costs.

In one or more of the above aspects, the invention may comprise one or more of the following preferred features.

Preferably, said operations a), b), c) produce, on said first forming drum, a crown sleeve.

Preferably, the following building operation is carried out:
a′) providing a second forming drum rotating about its central axis (X′-X′).

Preferably, the following building operation is carried out:
b′) winding around a radially external surface of said second forming drum a further cut-to-size semifinished element, thereby forming a corresponding further component of said tyre being processed.

Preferably, said further semifinished element has, after having been wound around said second forming drum, further opposite ends juxtaposed with each other to form a junction zone.

Preferably, the following building operation is carried out:
c′) repeating operation b′) until completion of the building operations on said second forming drum.

Preferably, said operations a′), b′), c′) produce, on said second forming drum, a carcass sleeve.

Preferably, said subsequent operations comprise assembling said carcass sleeve with said crown sleeve during an operation of shaping said tyre being processed.

Preferably, the assembling of said carcass sleeve with said crown sleeve occurs on said second forming drum.

Preferably, the carcass sleeve is transferred from said second forming drum to a shaping drum.

Preferably, the crown sleeve is transferred from said first forming drum to said shaping drum.

Preferably, the shaping operation is carried out on said shaping drum.

Preferably, following a stop caused by said stop signal, a restoration operation is carried out on said tyre being processed.

Preferably, said restoration operation comprises a manual intervention to repair the identified junction zone and make the tyre being processed suitable for the next operations.

Preferably, said restoration operation comprises a removal of the semifinished element having said at least one identified junction zone and a subsequent repetition of operation b).

Preferably, said two-dimensional image is acquired in the visible spectrum.

Preferably, identifying said at least one junction zone comprises training a first Artificial Intelligence, AI, agent with a multiplicity of training images.

Preferably, each training image represents a different junction zone, so that the first AI agent can recognise the presence of a junction zone.

Preferably, identifying said at least one junction zone comprises activating the trained first AI agent so that it operates on said two-dimensional image and identifies, in said two-dimensional image, the junction zone.

Preferably, a second AI agent is trained with said reference images.

Preferably, the second AI agent can classify junction zones on the basis of said reference images.

Preferably, the trained second AI agent is activated so that it operates on the identified junction zone and classifies said identified junction zone.

Preferably, said second AI agent executes the step of comparing said identified junction zone with the reference images.

Preferably, said second AI agent executes the step of selecting the junction zone type corresponding to the identified junction zone.

Preferably, said second AI agent executes the step of classifying said identified junction zone.

Preferably, comparing said at least one identified junction zone with said reference images comprises dividing said at least one identified junction zone into a plurality of sub-parts.

Preferably, comparing said at least one identified junction zone with said reference images comprises comparing each one of said sub-parts with each one of the reference images.

Preferably, said sub-parts are in an odd number.

Preferably, said sub-parts have a substantially square shape.

Preferably, said consent signal contains information representative of the selected junction zone type.

Preferably, said stop signal contains information representative of the selected junction zone type.

Preferably, said at least one two-dimensional image comprises a plurality of two-dimensional images.

Preferably, said component comprises one or more of: a tread band; one or more underbelt layers; one or more belt strips; a liner; an underliner; a complex; one or more carcass plies; one or more sidewall strips; one or more sidewall insert strips.

Preferably, said first building device produces, on said first forming drum, a crown sleeve.

Preferably, the apparatus comprises a second forming drum rotating about its central axis.

Preferably, the apparatus comprises a second building device.

Preferably, the second building device is configured for winding around a radially external surface of said second forming drum a further cut-to-size semifinished element, thereby forming a corresponding further component of said tyre being processed.

Preferably, said further semifinished element has, after having been wound around said second forming drum, further opposite ends juxtaposed with each other to form a junction zone.

Preferably, said second building device produces, on said second forming drum, a carcass sleeve.

Preferably, said subsequent operations comprise an operation of shaping said tyre being processed.

Preferably, said apparatus comprises a shaping device.

Preferably, said shaping device is configured for assembling said carcass sleeve with said crown sleeve during an operation of shaping said tyre being processed.

Preferably, said apparatus comprises a moving member for moving said tyre being processed to a restoration zone following the generation of said stop signal.

Preferably, said processing device is equipped with a first Artificial Intelligence, AI, agent.

Preferably, the first AI agent is trained with a multiplicity of training images.

Preferably, each training image represents a different junction zone, so that the first AI agent can recognise the presence of a junction zone.

Preferably, said first AI agent is configured for analysing said two-dimensional image and identifying, in said two-dimensional image, the junction zone.

Preferably, said processing device is equipped with a second AI agent.

Preferably, said second AI agent is trained with said reference images.

Preferably, the second AI agent can classify junction zones on the basis of said reference images.

Preferably, said second AI agent is configured for analysing the identified junction zone and classifying said identified junction zone.

Preferably, said second AI agent is configured for executing said step of comparing said identified junction zone with the reference images.

Preferably, said second AI agent is configured for executing said step of selecting the junction zone type corresponding to the identified junction zone.

Preferably, said second AI agent is configured for executing said step of classifying said identified junction zone.

Preferably, in order to compare said at least one identified junction zone with said reference images, said processing device is configured for dividing said at least one identified junction zone into a plurality of sub-parts.

Preferably, in order to compare said at least one identified junction zone with said reference images, said processing device is configured for comparing each one of said sub-parts with each one of the reference images.

Further features and advantages will become more apparent in the light of the following detailed description of a preferred, but non-limiting, embodiment of the invention. Such description is provided herein with reference to the annexed drawings, which are also supplied by way of non-limiting example, wherein:

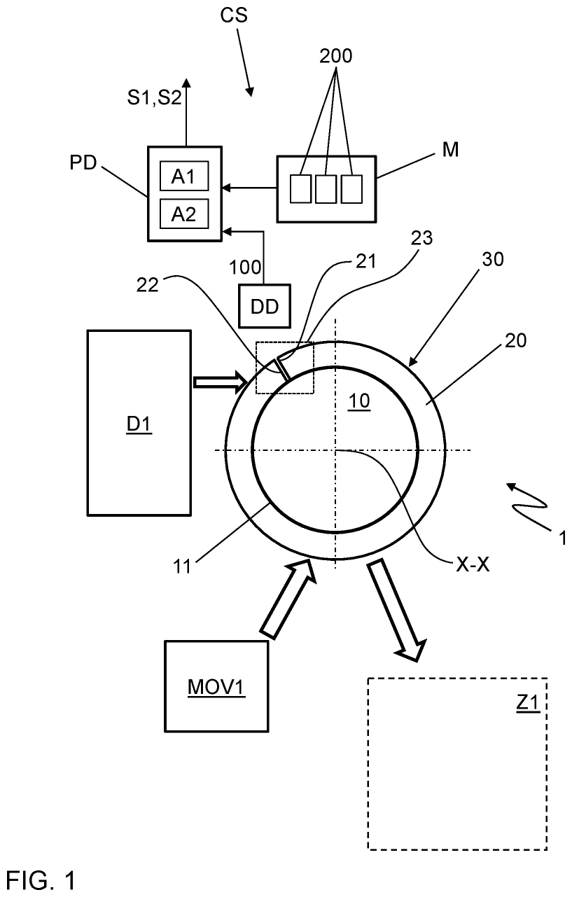

FIG. 1 shows a block diagram of an apparatus suitable for executing the process according to the invention;

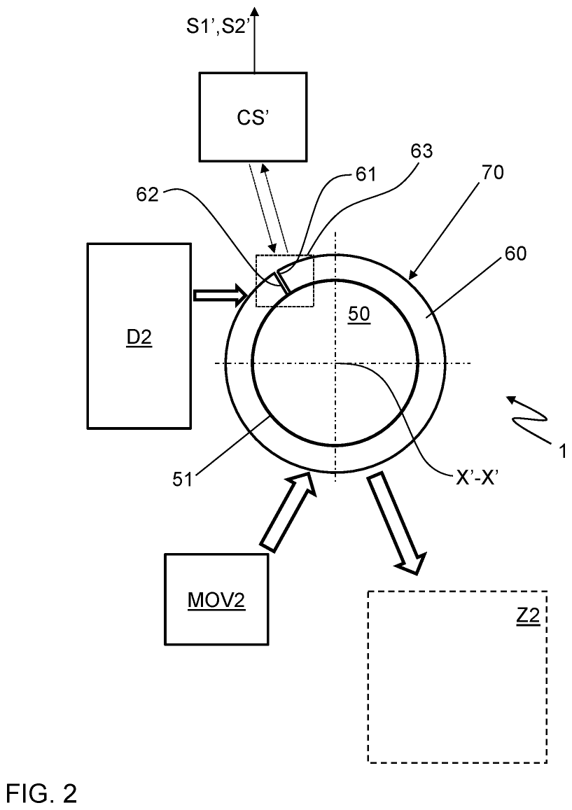

FIG. 2 shows further parts of the apparatus of FIG. 1;

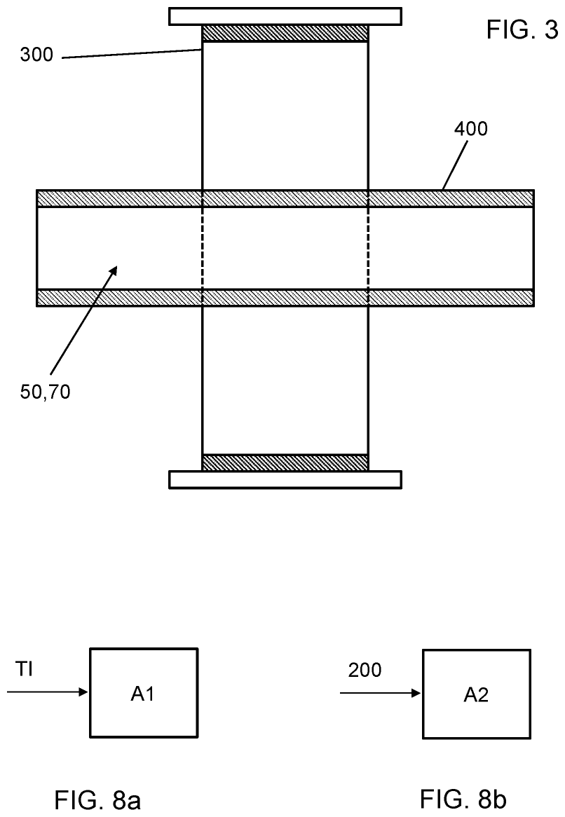

FIG. 3 schematically shows a processing step that may be included in the process according to the invention;

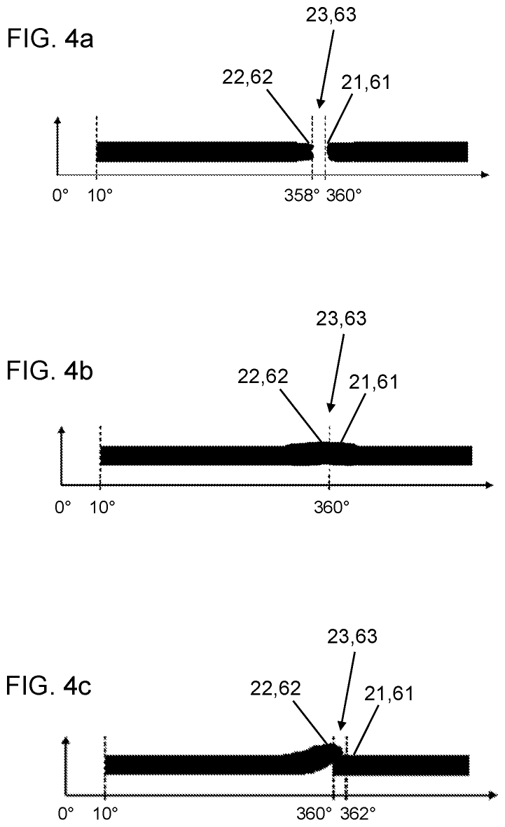

FIGS. 4a-4c show some possible configurations of an element used in the process according to the invention;

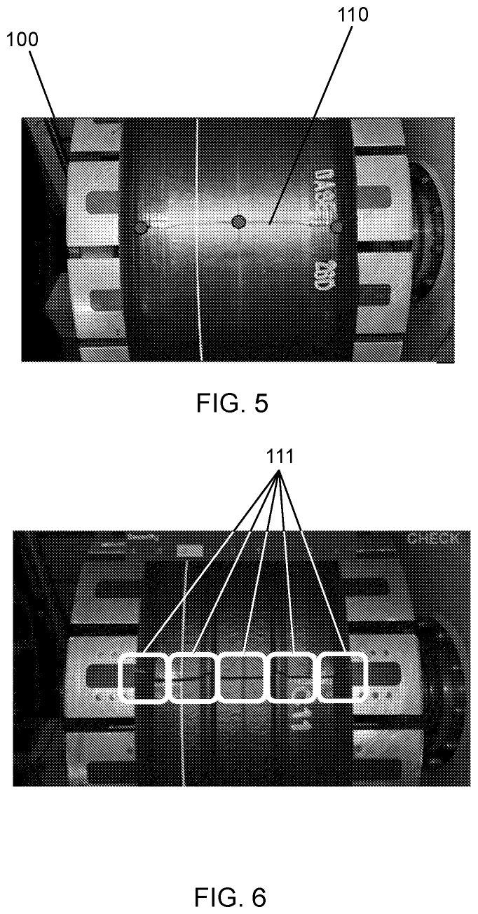

FIGS. 5-7 show some examples of images that may be used in the process according to the invention;

FIGS. 8a-8b schematically show some operations that may be carried out in the process according to the invention;

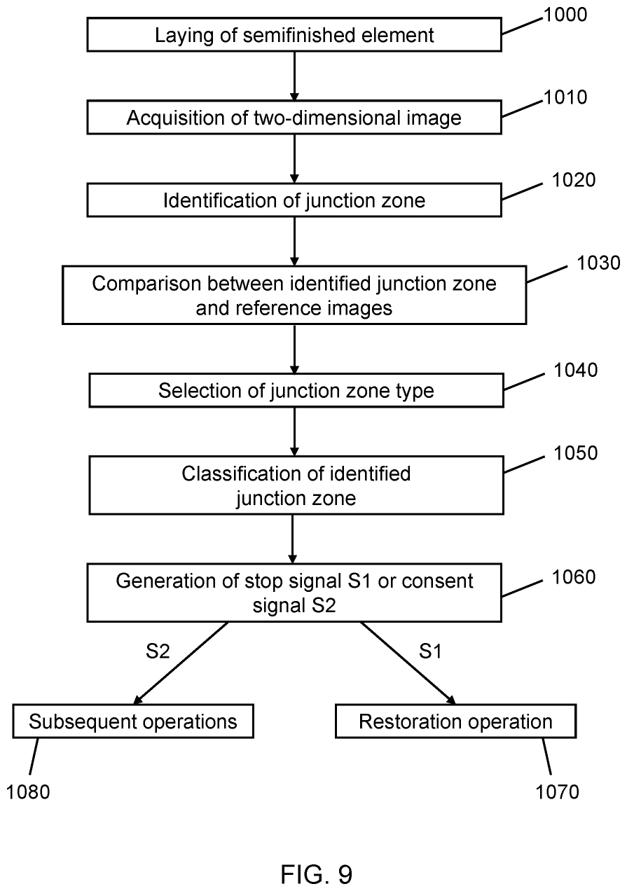

FIG. 9 is a flow chart representing the process according to the invention;

FIG. 10 schematically shows one possible embodiment of a part of the apparatus of FIG. 1.

With reference to the accompanying figures, numeral 1 designates as a whole an apparatus for building tyres for wheels of vehicles.

The apparatus 1 (FIG. 1) comprises a first forming drum 10 rotating about its central axis X-X.

The apparatus 1 further comprises a first building device D1, configured for winding around a radially external surface of the first forming drum 10 a cut-to-size semifinished element 20, thereby forming a corresponding component 30 of a tyre being processed.

For example, the component 30 comprises one or more of: a tread band; one or more underbelt layers; one or more belt strips; a liner; an underliner; a complex; one or more carcass plies; one or more sidewall strips; one or more sidewall insert strips.

The semifinished element 20 has, after having been wound around the first forming drum 10, opposite ends 21, 22 juxtaposed with each other to form a junction zone 23.

FIGS. 4a-4c schematically show some possible configurations of a junction zone, represented in straightened form in a Cartesian plane, wherein the axis of abscissas indicates the circumferential angular development relative to the forming drum, and the axis of ordinates indicates the distance from the radially external surface of the forming drum. In FIG. 4a, the angular distance between the ends 21, 22 is approximately 2°; in FIG. 4b, the two ends 21, 22 are in mutual contact with substantially no overlap; in FIG. 4c, the end 22 overlaps the end 21 for about 2°.

The building process executed by the apparatus 1 comprises, therefore, the following building operations:
a) providing the first forming drum 10;
b) winding the semifinished element 20 around the radially external surface 11 of the first forming drum 10, thereby forming the component 30;
c) repeating operation b) until completion of the building operations on the first forming drum 10.

Preferably, operations a), b), c) result in the formation, on the first forming drum 10, of a cylindrical crown sleeve 300 consisting of, as will be further described below, at least one belt layer radially surmounted by a tread band.

In one embodiment, the apparatus 1 comprises also a second forming drum 50 rotating about its central axis X′-X′ (FIG. 2).

The apparatus 1 further comprises a second building device D2.

The second building device D2 is configured for winding around a radially external surface of the second forming drum 50 a further cut-to-size semifinished element 60, thereby forming a corresponding further component 70 of the tyre being processed.

The further semifinished element 60 has, after having been wound around the second forming drum 50, further opposite ends 61, 62 juxtaposed with each other to form a junction zone 63.

FIGS. 4a-4c show some possible configurations of the junction zone 63.

The building process executed by the apparatus 1 may comprise, therefore, the following building operations:
a′) providing the second forming drum 50;
b′) winding the further semifinished element 60 around the radially external surface 51 of the second forming drum 50, thereby forming the further component 70;
c′) repeating operation b′) until completion of the building operations on the second forming drum 50.

Preferably, operations a′), b′), c′) result in the formation, on the second forming drum 50, of a cylindrical carcass sleeve 400 consisting of, as will be further described below, at least one carcass ply associated with a pair of annular anchoring structures.

The first and second building devices D1, D2 are per se known and will not therefore be described any further.

The process according to the present invention may also comprise other operations following the above-described building operations.

Preferably, such subsequent operations may comprise assembling the carcass sleeve 400 with the crown sleeve 300 during an operation of shaping the tyre being processed.

In this regard, the Applicant observes that the crown sleeve 300 and the carcass sleeve 400 are normally manufactured separately at respective stations (comprising, respectively, said first and second forming drums 10, 50), to be then assembled together at a later time.

More specifically, when making the carcass sleeve 400, the carcass ply(ies) is (are) applied onto the second forming drum 50 to obtain a carcass sleeve 400 having a substantially cylindrical shape. The annular structures for anchorage to the beads are fitted or formed on the opposite end flaps of the carcass ply(ies), which are then turned up around the annular structures so as to enclose them in a sort of loop.

At the same time, on the first forming drum 10 the crown sleeve 300 is made, which comprises the belt layers applied with mutual radial overlapping, and optionally the tread band applied in a position radially external to the belt layers.

The crown sleeve 300 is then picked up from the first forming drum 10 to be coupled to the carcass sleeve 400 during said assembling step.

For this purpose, the crown sleeve 300 is arranged coaxially around the carcass sleeve 400 (FIG. 3), and then the carcass ply(ies) is (are) shaped into a toroidal configuration by moving the beads axially towards each other and simultaneously introducing a fluid under pressure into the carcass sleeve 400, so as to cause a radial expansion of the carcass ply(ies) until the latter adhere(s) to the radially internal surface of the crown sleeve 300.

In one embodiment, the assembling of the carcass sleeve 400 with the crown sleeve 300 can be carried out on the same drum used for making the carcass sleeve 400 (i.e. the second forming drum 50); this is commonly referred to as a “single-step building process” or “unistage process”.

In one embodiment, a so-called “two-step” building process is carried out, wherein the carcass sleeve 400 is transferred from the second forming drum 50 to a shaping drum 70, and the crown sleeve 300 is transferred from the first forming drum 10 to said shaping drum 70, so that the shaping operation occurs on the shaping drum 70.

The apparatus 1 comprises a control system CS, which, as will become apparent below, performs the task of verifying whether the junction zone 23 has been made correctly or not.

The control system CS comprises a memory M.

The memory M stores a plurality of reference images 200.

Each reference image 200 represents, whether alone or combined with one or more other reference images, a junction zone type.

From a practical viewpoint, the reference images 200 represent the possible configurations of the junction zone 23.

Preferably, the reference images 200 show the possible configurations of the junction zone 23 in a view from a radial direction relative to the first forming drum 10.

In one embodiment, each reference image 200 wholly represents a junction zone type, i.e. one possible configuration of the junction zone 23 considered in its entirety.

In a different embodiment, each reference image 200 represents a sub-part of one possible junction zone.

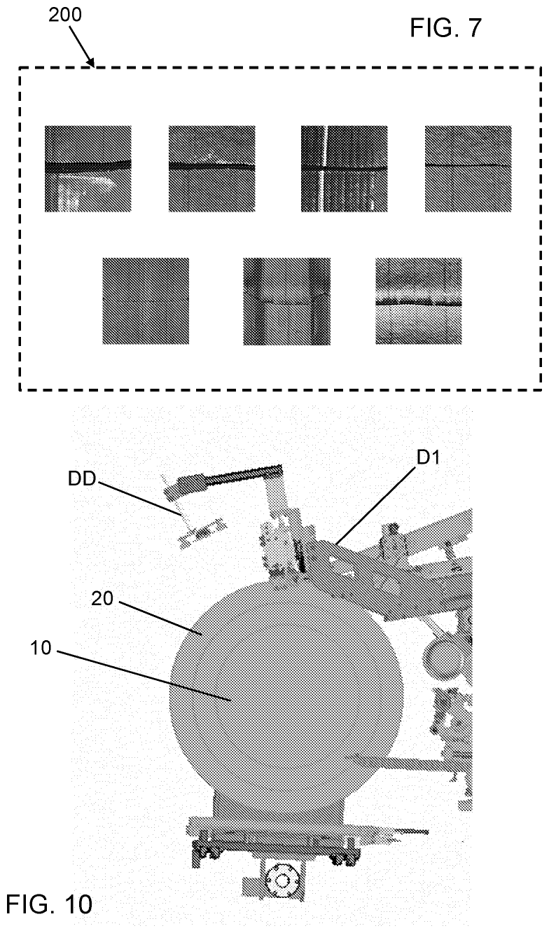

FIG. 7 schematically shows some examples of reference images 200; in this example, each reference image 200 corresponds to a sub-part of a junction zone corresponding to one fifth of the whole junction zone.

The control system CS comprises a detection device DD.

The detection device DD is configured for acquiring at least one two-dimensional image 100 of the tyre being processed.

The detection device DD may be a video camera, e.g. a matrix camera.

Advantageously, the detection device DD may be associated with an illuminator (not shown).

The illuminator performs the task of illuminating, by means of radiations having an adequate wavelength, the area to be acquired by the detection device DD, i.e. the area corresponding to the image 100.

The illuminator may be either integrated with the detection device DD (e.g. a flash unit integrated into a camera) or provided as a separate device. At any rate, the illuminator is preferably synchronized with the detection device DD so as to illuminate the area of interest when the detection device DD acquires the image 100.

For example, the two-dimensional image 100 may be acquired in the visible spectrum, preferably with wavelengths ranging from 380 nm to 780 nm.

In one embodiment, the two-dimensional image 100 is a colour photograph.

Preferably, the two-dimensional image 100 has a high resolution.

The image 100 is acquired in a view from a radial direction relative to the first forming drum 10.

FIG. 10 schematically shows one possible position of the detection device DD. The part of the first building device D1 shown in FIG. 10 is mechanically configured to maintain tangency with the first forming drum 10 for any drum diameter that can be processed. The detection device DD can advantageously be mounted on such part of the first building device D1, so that the distance from the radially external surface of the first forming drum 10 will remain substantially constant and controlled, while also allowing the acquisition of the two-dimensional image 100 from a substantially radial direction.

The Applicant observes that, due to the fact that the detection device DD operates with wavelengths that are harmless for the operators involved, the positioning of the detection device DD is simpler and less subject to constraints than devices based on laser technologies.

FIG. 5 shows an example of a two-dimensional image 100 acquired by the detection device DD.

Preferably, once the laying of the semifinished element 20 is complete, a predetermined additional rotation is imparted to the first forming drum 10 to move the junction zone 23 into a position substantially facing the detection device DD.

The Applicant observes that, thanks to the processing technique described and claimed herein, it is not necessary for the additional rotation to be computed with particular precision. In fact, as will become apparent below, the invention provides for recognising the junction zone within the acquired image, regardless of the position of the junction zone within said image.

In one embodiment, multiple two-dimensional images 100 are acquired, each one being representative of a respective portion of the semifinished element 20. This solution may be useful in the presence of junction zones that are particularly wide in the circumferential direction. The processing described below can be applied either to a combination of multiple two-dimensional images or to each one of such images.

The control system CS comprises a processing device PD.

The processing device PD is connected to the memory M and to the detection device DD.

The processing device PD is configured for identifying, in the image 100, at least one junction zone 110 in a radially external position of the tyre being processed.

In FIG. 5 it is also possible to see the junction zone 110 identified in the acquired image 100.

Note that reference 23 indicates the “real” junction zone between the ends 21, 22 of the semifinished element 20, whereas reference 110 indicates the junction zone identified in the image 100, i.e. the portion of the image 100 where the junction zone is represented.

In one embodiment, the processing device PD is equipped with a first Artificial Intelligence, AI, agent A1.

The first AI agent A1 is trained with a multiplicity of training images TI (FIG. 8a), each one representing a different junction zone.

In this manner, the first AI agent A1 can recognise the presence of a junction zone.

For example, the training images TI may consist of 50-100 images of junctions of various types (straight junction, slightly shaped junction, markedly shaped junction, etc.), so as to allow the first AI agent A1 to identify, in general, the main features of a junction zone and recognise its presence in a given image.

The first AI agent A1 is activated to analyse the two-dimensional image 100 and identify, in said two-dimensional image 100, the junction zone 110.

For example, the first AI agent A1 may be an “Image Detection” neural network which, given an input image (i.e. the two-dimensional image 100), will output the coordinates of the image portion containing the searched object (i.e. the junction zone).

The processing device PD is configured for comparing the at least one identified junction zone 110 with each one of the reference images 200.

The processing device PD is also configured for selecting, as a function of such comparison, a junction zone type corresponding to the identified junction zone 110.

The processing device PD is further configured for classifying the identified junction zone 110 on the basis of the selected junction zone type.

In order to compare the at least one identified junction zone 110 with the reference images 200, select the junction zone type corresponding to the identified junction zone 110, and classify the identified junction zone 110, the processing device PD may be equipped with a second AI agent A2.

The second AI agent A2 is trained with the reference images 200 (FIG. 8b).

Thus, the second AI agent A2 can classify the junction zones on the basis of the reference images.

The second AI agent A2 is activated to analyse the identified junction zone 110 and classify the same identified junction zone 110.

For example, the second AI agent A2 may be an “Image Classification” neural network which, given an input image (i.e. the identified junction zone 110), will output a classification of such image.

In one embodiment, the identified junction zone 110 is divided into a plurality of sub-parts 111; each one of such sub-parts 111 is then compared with each one of the reference images 200.

The sub-parts 111 are preferably in an odd number. The Applicant observes that, in this way, it is possible to analyse a substantially central sub-part and remaining sub-parts distributed mirrored on the right and on the left of said central sub-part. For example, the sub-parts 111 may be five in number.

Preferably, the sub-parts 111 may have a substantially square shape.

In one embodiment, the sub-parts 111 have all substantially the same shape and size.

Preferably, the sub-parts 111 have substantially the same shape and the same size as the reference images 200.

Preferably, when the identified junction zone 110 is divided into sub-parts 111, each reference image 200 does not identify one junction zone type. In fact, it is a combination of multiple reference images 200 (possibly equal to each other) that defines a junction zone type.

As aforesaid, each sub-part 111 is compared with the reference images 200 and, based on such comparison, the identified junction zone 110 is classified.

From a practical viewpoint, the junction zone type represents the shape of the junction, i.e. it indicates whether the two joined ends adhere to each other throughout the length of the junction, with no spacing or overlap, or the two ends adhere to each other on one side only and are spaced apart on the opposite side, or there is a gap between the two ends throughout the length of the junction, etc.

Each junction zone type is associated with a respective classification; for example, if the ends adhere well to each other with no spacing or overlap, the classification may be “OK”; if there is some small gap/overlap, the classification may be “repairable KO”; if the gap/overlap between the two ends exceeds a certain acceptable threshold, the classification will be “non-repairable KO”.

In one embodiment, the processing device PD (including the first and/or second AI agents A1, A2) may be integrated into the detection device DD. For example, the detection device DD and the processing device PD may be implemented as a camera having computational capability and equipped with analysis software, suitable for performing the operations described herein.

The processing device PD is also configured for generating, as a function of such classification, either a stop signal S1 or a consent signal S2.

The stop signal S1 causes the first building device D1 to stop.

For example, the stop signal is generated when the classification is “repairable KO” or “non-repairable KO”.

Such stop allows an operator to verify the defect in detail. To this end, a moving member MOV1, MOV2 is activated to move the tyre being processed to a restoration zone Z1, Z2.

In particular, a first moving member MOV1 can operate on the first forming drum 10 to move the tyre being processed on the first forming drum 10 to a first restoration zone Z1; a second moving member MOV2 can operate on the second forming drum 50 to move the tyre being processed on the second forming drum 50 to a second restoration zone Z2.

Following the examination by the operator, one of the following restoration operations can be carried out:
a manual intervention, carried out by the operator, to repair the junction zone 23 (represented by the identified junction zone 110 in the image 100) and make the tyre suitable for subsequent operations; this occurs, for example, when the “repairable KO” classification is confirmed;
removal of the semifinished element 20 having a junction zone 23 corresponding to the identified junction zone 110, followed by a repetition of operation b)—i.e., laying of a new semifinished element as a substitute for the removed one; this occurs, for example, when the “non repairable KO” classification is confirmed.

The consent signal S2 permits/activates the execution of subsequent operations on the tyre being processed.

The consent signal S2 is generated, for example, when the classification is “OK”.

For example, such subsequent operations may comprise, as mentioned above, assembling the crown sleeve 300 with the carcass sleeve 400 during the shaping operation.

More generally, the subsequent operations may comprise steps necessary for completing the building of the tyre being processed.

Preferably, the stop signal S1 and/or the consent signal S2 contain information representative of the selected junction zone type.

Such information may be useful to signal the type of defect detected (e.g. the junction zone shows a significant gap on one side, while the ends are properly joined on the opposite side) and thus facilitate the operator's intervention.

Such information may also be used for filing and/or statistical analysis purposes.

It should be noted that, as schematically illustrated in FIG. 2, a further control system CS′ may operate on the junction zone 63 of the further semifinished element 60 laid on the second forming drum 50. The further control system CS′ is wholly similar to the control system CS described above. Whenever necessary, the images used for training the first and/or second artificial intelligence agents may be different between the two control systems CS, CS′.

In this manner, the junction zone 63 can be associated with a respective image to be subjected to the above-described analysis. Thus, either a stop signal S1′ or a consent signal S2′ can be generated also for the building operations carried out on the second forming drum 50.

The flow chart of FIG. 9 summarizes the steps that may be performed during the building process according to the present invention.

At block 1000, the semifinished element 20 is laid onto the first forming drum 10, creating the junction zone 23 with its opposite ends 21, 22.

At block 1010, the two-dimensional image 100 is acquired, which represents the junction zone 23.

At block 1020, the junction zone 110, corresponding to the junction zone 23 of the semifinished element 20, is identified in the image 100.

At block 1030, the identified junction zone 110 is compared with the reference images 200.

At block 1040, the junction zone type corresponding to the identified junction zone 110 is selected as a function of the comparison made at block 1030.

At block 1050, the identified junction zone 110 is classified on the basis of the junction zone type selected at block 1040.

At block 1060, either the stop signal S1 or the consent signal S2 is generated based on the classification made at block 1050.

At block 1070, following the generation of the stop signal S1, a restoration operation is carried out.

At block 1080, following the generation of the consent signal S2, subsequent operations are performed on the tyre being processed.

1-28. (canceled)

29. A process for building tyres for wheels of vehicles, comprising the following building operations:
a) providing a first forming drum configured to rotate about its central axis;
b) winding around a radially external surface of said first forming drum a cut-to-size semifinished element, thereby forming a corresponding component of a tyre being processed, wherein said semifinished element has, after having been wound around said first forming drum, opposite ends juxtaposed with each other to form a junction zone;
c) repeating operation b) until completion of the building operations on said first forming drum;
wherein, during said building operations, a checking operation is performed on said tyre being processed, at least at the end of an operation b), said checking operation comprising:
acquiring at least one two-dimensional image of said tyre being processed;
identifying, in said image, at least one junction zone in a radially external position of said tyre being processed;
providing a plurality of reference images, wherein each reference image represents, whether alone or combined with one or more other reference images, a junction zone type;
comparing said at least one identified junction zone with each one of the reference image;
selecting, as a function of said comparison, a junction zone type corresponding to said at least one junction zone identified in said image;
classifying said at least one identified junction zone on the basis of the selected junction zone type; and
generating, as a function of said classification, either a stop signal or a consent signal, wherein said stop signal causes said building operations to stop and said consent signal activates the execution of subsequent operations on said tyre being processed.

30. The process according to claim 29, wherein said operations a), b), c) produce, on said first forming drum, a crown sleeve.

31. The process according to claim 30, comprising executing the following building operations:
a′) providing a second forming drum rotating about its central axis;
b′) winding around a radially external surface of said second forming drum a further cut-to-size semifinished element thereby forming a corresponding further component of said tyre being processed, wherein said further cut-to-size semifinished element has, after having been wound around said second forming drum, further opposite ends juxtaposed with each other to form a junction zone; and
c′) repeating operation b′) until completion of the building operations on said second forming drum,
wherein said operations a′), b′), c′) produce, on said second forming drum, a carcass sleeve.

32. The process according to claim 31, wherein said subsequent operations comprise assembling said carcass sleeve with said crown sleeve during an operation of shaping said tyre being processed.

33. The process according to claim 32, wherein the assembling of said carcass sleeve with said crown sleeve occurs on said second forming drum.

34. The process according to claim 32, comprising:
transferring the carcass sleeve from said second forming drum to a shaping drum;
transferring the crown sleeve from said first forming drum to said shaping drum; and
executing the shaping operation on said shaping drum.

35. The process according to claim 32, comprising executing, after a stop caused by said stop signal, a restoration operation on said tyre being processed.

36. The process according to claim 35, wherein said restoration operation comprises one of:
a manual intervention to repair the identified junction zone and make the tyre being processed suitable for the subsequent operations; or
removal of the semifinished element having said at least one identified junction zone, followed by a repetition of operation b).

37. The process according to claim 36, wherein said two-dimensional image is acquired in the visible spectrum.

38. The process according to claim 37, wherein identifying said at least one junction zone comprises:
training a first Artificial Intelligence, AI, agent with a multiplicity of training images, each one representing a different junction zone, so that the first AI agent can recognise presence of a junction zone; and
activating the trained first AI agent so that it operates on said two-dimensional image and identifies, in said two-dimensional image, the junction zone.

39. The process according to claim 38, comprising:
training a second AI agent with said reference images, so that the second AI agent can classify junction zones on the basis of said reference images;
activating the trained second AI agent so that the trained second AI agent operates on the identified junction zone and classifies said identified junction zone.

40. The process according to claim 39, wherein said second AI agent executes the steps of comparing said identified junction zone with the reference images, selecting the junction zone type corresponding to the identified junction zone, and classifying said identified junction zone.

41. The process according to claim 40, wherein comparing said at least one identified junction zone with said reference images comprises:
dividing said at least one identified junction zone into a plurality of sub-parts; and
comparing each one of said sub-parts with each one of the reference images.

42. The process according to claim 41, wherein said sub-parts are in an odd number.

43. The process according to claim 42, wherein said sub-parts have a substantially square shape.

44. The process according to claim 40, wherein said stop signal and/or said consent signal contain information representative of a type of the selected junction zone.

45. The process according to claim 44, wherein said at least one two-dimensional image comprises a plurality of two-dimensional images.

46. The process according to claim 45, wherein said component or said further component comprises one or more of: a tread band; one or more underbelt layers; one or more belt strips; a liner; an underliner; a complex; one or more carcass plies; one or more sidewall strips; and one or more sidewall insert strips.
